(19) United States
(12) Patent Application Publication
(10) Pub. No.: US 2007/0233366 A1
(43) Pub. Date: Oct. 4, 2007

(54) METHOD AND DEVICE INCLUDING A MAP MEDIUM FOR CORRECTING NAVIGATION INFORMATION

(75) Inventor: Ping-Chih Lin, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: MITAC INTERNATIONAL CORP., Gueishan Shiang (TW)

(21) Appl. No.: 11/694,271

(22) Filed: Mar. 30, 2007

(30) Foreign Application Priority Data
Apr. 4, 2006 (TW) 95111884

(51) Int. Cl. G01C 21/00

(52) U.S. Cl. 701/207; 701/208; 701/213

(57) ABSTRACT

A method and device including a map medium for correcting navigation information is described. The method includes the following steps: receiving a height varying signal; receiving a plane coordinate; comparing identification information with the height varying signal, the identification information predefined to represent adjacent roads on different planes in a map medium; and outputting an identification result according to the comparing result.

### CROSS-REFERENCE TO RELATED APPLICATIONS

This non-provisional application claims priority under 35 U.S.C. §119(a) on Patent Application No(s). 95111884 filed in Taiwan, R.O.C. on Apr. 4, 2006, the entire contents of which are hereby incorporated by reference.

### BACKGROUND OF THE INVENTION

1. Field of Invention

The present invention relates to a method and device in the satellite navigation, and more particularly to a method and device for correcting navigation information in the satellite navigation.

2. Related Art

As the technology progress and the cost down, the satellite position device becomes very popular. As the standard of living improves, people have more chance to travel or adventure, the sale amount of the satellite position device is increasing in the past few years. No matter people on business or travel, the satellite position device can precisely locate the people and the architectures in the wide and complex traffic network. Therefore many manufactures research and develop actively in the satellite position device to reach consumer's favor.

According to the conventional theory, the satellite position device has a satellite receiver capable of receiving the satellite signal from the satellite groups out of the Earth. The satellite position device can compute the present location by the algorithm of geometry and time after receiving at least three satellite signals from the satellites and display a mathematical value (ex. longitude and latitude) on a screen of the satellite position device, and the user realizes the present location from the screen.

The satellite position device also has navigation software providing at least one map medium (ex. the map of Taiwan) displayed on the screen. The satellite position device receives the satellite signal and computes the mathematical value (ex. longitude and latitude) of the present location. The navigation software brings the mathematical value into the map medium and gets the map of matching the present location. The map on the screen is provided for the user to know the present location clearly. According to the navigation path or information provided by the navigation software, the user may follow the direction and reduce the possibility of missing.

The conventional satellite position device has some problems in practice. One of the problems is the tolerance from the Earth rotation and revolution, ionosphere interference, reflection signal transmitting multiple paths and so on causing the position incorrect. The tolerance of general satellite position device is about 10 meter, but it could lead the user to incorrect path. For example, the road A adjacent to the road B, the user sees a location mark of the present location on the screen can not identify where in the road A or in the road B due to the tolerance.

Furthermore, the conventional navigation software can not provide the precise road information (ex. viaduct, underground passage etc.) causing the user unable to determine the correct road. The tolerance and the insufficient road information cause the user confusing and lost easily. For example, the user follows the satellite position device to the destination coordinate but reaches the viaduct above the destination coordinate. The user must waste a lot of time on moving nearby the viaduct to reach the correct destination. Therefore the above problems cause the inconvenience and waste of the precious time in the road.

### SUMMARY OF THE INVENTION

According the above satellite navigator has problems such as providing the incorrect navigation information. Therefore the present invention provides a method and a device including a map medium for correcting navigation information. The present invention provides the precise navigation information for user.

In an embodiment of the present invention, a method for correcting navigation information includes the following steps: receiving a height varying signal; receiving a plane coordinate; comparing identification information with the height varying signal, the identification information predefined to represent adjacent roads on different planes in a map medium; and outputting the result of comparing as an identification result. More precise navigation information is provided for the user to avoid determining the incorrect road.

In another embodiment of the present invention, a device for correcting navigation information includes an acceleration sensor, a processing unit, a storage unit and a display unit. The acceleration sensor generates and transmits an acceleration signal to the processing unit. The processing unit receives the acceleration signal and outputs a height varying signal. The storage unit stores a map medium including identification information predefined to represent adjacent roads on different planes in the map medium. The display unit shows a map screen according to the map medium. Comparing the height varying signal with the identification information outputs correct navigation information for user.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is an explanatory diagram for a device for correcting navigation information according to an embodiment of the present invention.

FIG. 2 is a flow chart for a method for correcting navigation information according to an embodiment of the present invention.

FIG. 3 is another flow chart for a method for correcting navigation information according to an embodiment of the present invention.

### DETAILED DESCRIPTION OF THE INVENTION

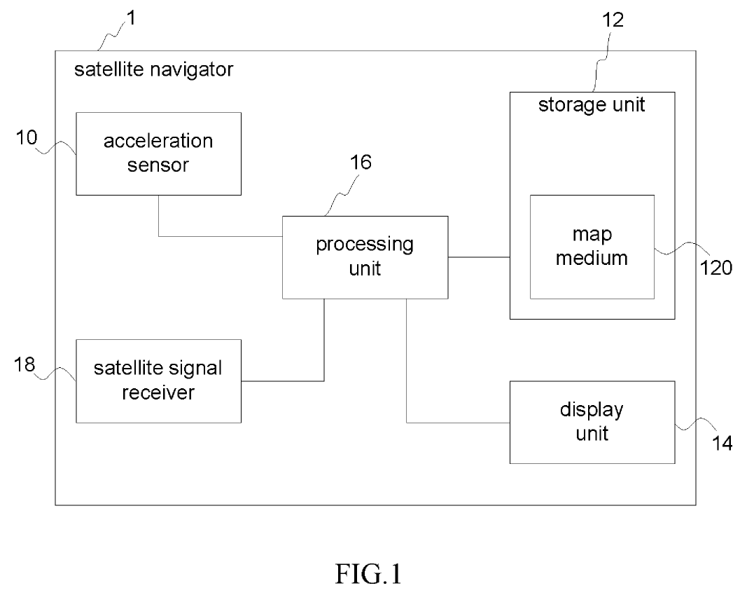

Please refer to FIG. 1. A satellite navigator 1 includes an acceleration sensor 10, a storage unit 12, a display unit 14, and a processing unit 16. The acceleration sensor 10 generates and transmits an acceleration signal to the processing unit 16. The storage unit 12 stores a map medium 120. The map medium 120 includes identification information representing adjacent roads on different planes in the map medium 120. The display unit 14 shows a map screen according to the map medium 120. The processing unit 16 achieves a height varying signal according to the acceleration signal, and compares the height varying signal with the identification information to output an identification result.

The satellite navigation device 1 further includes a satellite signal receiver 18. The satellite signal receiver 18 receives and transmits a satellite signal to the processing unit 16. The processing unit 16 computes a longitude value and a latitude value from the satellite signal. Both of the longitude and latitude values form a plane coordinate. The processing unit 16 compares the plane coordinate and the height varying signal with the identification information to achieve an identification result. A location mark in the map screen indicates the present location of the satellite navigator 1.

The processing unit 16 receives the plane coordinate and the identification information corresponding to the height varying signal to display the location mark or a navigation path at a road in the map with the identification information.

The map medium 120 is used for a satellite navigator 1 to show a plurality of maps. The identification information is predefined to represent adjacent roads on different planes in the map medium 120 and can be compared with the height varying signal. The adjacent roads are the roads close to each other in the distance less than GPS location accuracy, or the roads on the same plane coordinate but in different heights. The identification information includes the height information (such as heights, height levels or positive/negative marks) of adjacent roads in the map medium 120. The location of the user is indicated by the plane coordinate and the height varying signal. If the adjacent roads exist on the plane coordinate, the height varying signal of the user is compared with the identification information to identify on which road the user is. The identification result is achieved by comparing identification information with the height varying signal by algorithm operation or hardware and provided to the user with the correct navigation information.

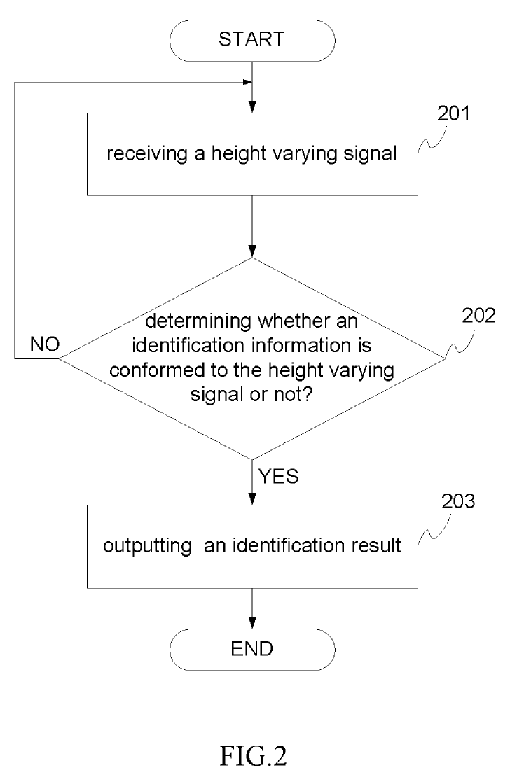

Please refer to FIG. 2. The method for correcting navigation information receives a height varying signal and a plane coordinate. And then compares identification information with the height varying signal and the plane coordinate, the identification information predefined to represent adjacent roads on different planes in a map medium. Finally, outputs identification result as the correct navigation information to prevent the user from being misled.

A method for correcting navigation information includes the following steps of:

Step 201: receiving a height varying signal.

Step 202: comparing the height varying signal with identification information and determining whether the identification information is conformed to the height varying signal? If yes, go forward the Step 203; if no, go back the Step 201.

Step 203: outputting the result of comparing as an identification result.

By the method of the invention, the more accurate navigation information is supplied to prevent the user from going to the adjacent incorrect road.

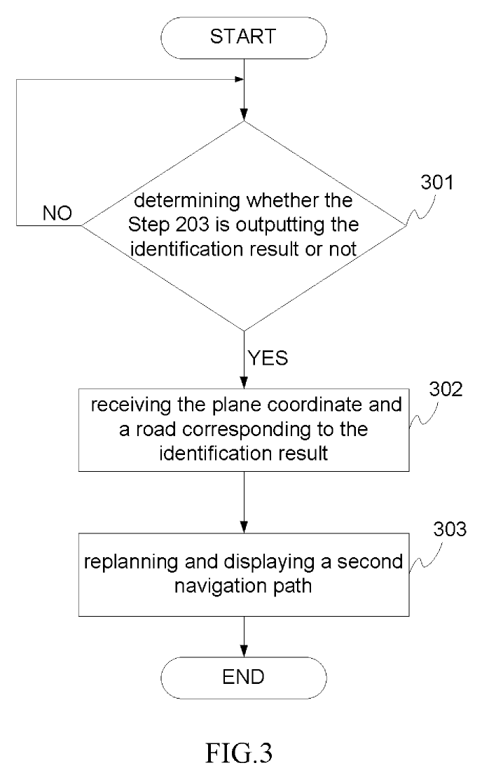

Please refer to FIG. 3. The identification result as a notice message is supplied to the user for more accurate navigation information. Before the above step of receiving the height varying signal and the plane coordinate, a first navigation path is planned by receiving a starting coordinate and an end coordinate. The method for correcting navigation information further includes the following steps of:

Step 301: determining whether the Step 203 is outputting the identification result? If yes, go forward the Step 302; if no, go back the Step 301.

Step 302: receiving the plane coordinate and a road corresponding to the identification result.

Step 303: planning the first navigation path to a second navigation path and providing the second navigation path as a new navigation path to the user.

The identification result shows a location mark at the new navigation path. Before receiving the height varying signal, receiving a satellite signal and computing a longitude value and a latitude value from the satellite signal. Both of the longitude and latitude values form a plane coordinate for identifying.

Before receiving the height varying signal, further includes the following step: reading an acceleration signal and achieving the height varying signal according to the acceleration signal for comparing with the identification information.

The user can get the most accurate navigation information and avoid some confusion like losing in the error road or undistinguishing the correct road by using the method of the invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for correcting navigation information, comprising the steps of:
receiving a height varying signal;
receiving a plane coordinate;
comparing identification information with the height varying signal, the identification information predefined to represent adjacent roads on different planes in a map medium; and
outputting an identification result according to the comparing result.

2. The method of claim 1, wherein the identification result is a notice message.

3. The method of claim 1, further comprising a step of receiving a starting coordinate and an end coordinate from the map medium and planning a first navigation path before the step of receiving the height varying signal and the plane coordinate.

4. The method of claim 3, wherein the identification result is a second navigation path achieved from the plane coordinate and a road corresponding to the identification result.

5. The method of claim 4, wherein the step of receiving the plane coordinate comprising:
reading a satellite signal;
computing a longitude value and a latitude value from the satellite signal; and
achieving the plane coordinate from the longitude value and the latitude value.

6. The method of claim 5, wherein the step of receiving the height varying signal comprising:
reading an acceleration signal; and
achieving the height varying signal according to the acceleration signal.

7. A device for correcting navigation information, comprising:
an acceleration sensor generating an acceleration signal;
a processing unit receiving the acceleration signal and outputting a height varying signal;
a storage unit storing a map medium including an identification information predefined to represent adjacent roads on different planes in the map medium; and
a display unit showing a map screen according to the map medium.

8. The device of claim 7, further comprising a satellite signal receiver receiving and transmitting a satellite signal to the processing unit to output a plane coordinate.

9. The device of claim 8, wherein the processing unit achieving a location mark in the map according to the plane coordinate.

10. The device of claim 9, wherein the location mark is achieved from the plane coordinate and the identification information corresponding to the height varying signal, the location mark is displayed at a road in the map with the identification information.

11. The device of claim 9, wherein the processing unit displaying a navigation path at a road in the map with the identification information according to the plane coordinate and the identification information corresponding to the height varying signal.

12. A map medium used for a satellite navigator comprising:
a plurality of maps; and
identification information predefined to represent adjacent roads on different planes in the map and supplied for comparing with a height varying signal.
